(19) United States
(12) Patent Application Publication
(10) Pub. No.: US 2025/0384869 A1
(43) Pub. Date: Dec. 18, 2025

(54) SYNTHESIZING BONE CONDUCTED SPEECH FOR AUDIO DEVICES

(71) Applicant: BOSE CORPORATION, Framingham, MA (US)

(72) Inventors: Marko STAMENOVIC, Truro, MA (US); Bryce IRVIN, Brooklyn, NY (US); Mikolaj Aleksander KEGLER, London (GB)

(21) Appl. No.: 19/237,821

(22) Filed: Jun. 13, 2025

Related U.S. Application Data
(60) Provisional application No. 63/660,005, filed on Jun. 14, 2024.

(51) Int. Cl. G10L 13/047

(52) U.S. Cl. CPC G10L 13/047

(57) ABSTRACT

Techniques, including wearable audio devices and systems implementing the techniques, for synthesizing bone conduction speech. Such techniques may include (i) inputting a first acoustic signal into a first machine-learning model, (ii) generating, with the first machine-learning model, a first bone conduction signal in a time domain or a spectral domain based, at least in part, on the first acoustic signal, (iii) generating, with the first machine-learning model, a transfer function that characterizes a relationship between the first acoustic signal and the first bone conduction signal based, at least in part, on the first acoustic signal, and (iv) training, using at least one of the first bone conduction signal or the transfer function, a second machine-learning model on a first device.

### CROSS-REFERENCE TO RELATED APPLICATION

This application claims the benefit of and priority to U.S. Provisional Application No. 63/660,005, filed Jun. 14, 2024, which is incorporated by reference herein in its entirety.

### FIELD

Aspects of the disclosure generally relate to wearable audio devices, and, more particularly, to techniques and wearable audio devices for synthesizing bone conducted speech.

### BACKGROUND

Audio devices, such as wearable audio devices (e.g., headphones or earbuds), are often utilized to output content to enable people to enjoy various forms of entertainment (e.g., music, videos, movies, television shows, sport events, games, podcasts, or other similar entertainment). Audio devices may also be utilized for voice communication with other devices. In some cases, an audio device implemented as a wearable audio device may include one or more acoustic sensors and/or vibration sensors to capture speech from the user of the wearable audio device (e.g., for transmission to another device). The acoustic sensor(s) may capture airborne speech from the user, while the vibration sensor(s) may capture bone conducted speech.

### SUMMARY

All examples and features mentioned below can be combined in any technically possible way.

Aspects of the present disclosure are directed to a method. The method generally includes (i) inputting a first acoustic signal into a first machine-learning model, (ii) generating, with the first machine-learning model, a first bone conduction signal in a time domain or a spectral domain based, at least in part, on the first acoustic signal, (iii) generating, with the first machine-learning model, a transfer function that characterizes a relationship between the first acoustic signal and the first bone conduction signal based, at least in part, on the first acoustic signal, and (iv) training, using at least one of the first bone conduction signal or the transfer function, a second machine-learning model on a first device.

In aspects, the method further includes (i) inputting a second acoustic signal captured using a first sensor included in the first device into the second machine-learning model, (ii), inputting a second bone conduction signal captured using a second sensor included in the first device into the second machine-learning model, and (iii) enhancing or suppressing, on the first device and using the second machine-learning model, speech from a user of the first device present in at least one of the second acoustic signal or the second bone conduction signal.

In aspects, the method further includes training, using a second acoustic signal and a second bone conduction signal, the first machine-learning model, where the second acoustic signal is captured using a first sensor included in a second device and the second bone conduction signal is captured using a second sensor included in the second device and where the first device and the second device are the same device model.

In aspects, the method further includes receiving, using a sensor included in a second device, the first acoustic signal, where the first device and the second device are the same device model.

In aspects, the transfer function is nonlinear, time-varying, user-specific, and device model-specific.

In aspects, at least one of: generating the first bone conduction signal in the time domain or the spectral domain based, at least in part, on the first acoustic signal includes using real spectral mapping or filtering, complex spectral mapping or filtering, or latent mapping or filtering, or generating the transfer function based, at least in part, on the first acoustic signal includes using time-domain mapping or filtering, real spectral mapping or filtering, complex spectral mapping or filtering, or latent mapping or filtering.

In aspects, the method further includes inputting at least one of a representation of a second device or a representation of a user of the second device into the first machine-learning model, where: generating the first bone conduction signal is further based, at least in part, on the at least one of the representation of the second device or the representation of the user of the second device, and generating the transfer function is further based, at least in part, on the at least one of the representation of the second device or the representation of the user of the second device.

In aspects, generating the transfer function based, at least in part, on the first acoustic signal includes using an encoder and a decoder both included in the first machine-learning model; and inputting the at least one of the representation of the second device or the representation of the user of the second device includes inputting the at least one of the representation of the second device or the representation of the user of the second device into the decoder.

In aspects, inputting the first acoustic signal into the first machine-learning model includes inputting a linguistic input representing the first acoustic signal into the first machine-learning model.

In aspects, the linguistic input is encoded in a multimodal latent space that includes text and audio.

In aspects, the first machine-learning model includes a neural network.

In aspects, the first audio device includes a wearable audio device.

Aspects of the present disclosure provide a first device that includes one or more processors. The one or more processors are configured to: (i) input a first acoustic signal into a first machine-learning model, (ii) generate, with the first machine-learning model, a first bone conduction signal in a time domain or a spectral domain based, at least in part, on the first acoustic signal, (iii) generate, with the first machine-learning model, a transfer function that characterizes a relationship between the first acoustic signal and the first bone conduction signal based, at least in part, on the first acoustic signal, and (iv) train, using at least one of the first bone conduction signal or the transfer function, a second machine-learning model on a second device.

In aspects, the one or more processors are further configured to: (i) input a second acoustic signal captured using a first sensor included in the first device into the second machine-learning model, (ii) input a second bone conduction signal captured using a second sensor included in the first device into the second machine-learning model, and (iii) enhance or suppress, on the first device and using the second machine-learning model, speech from a user of the first device present in at least one of the second acoustic signal or the second bone conduction signal.

In aspects, the one or more processors are further configured to: train, using a second acoustic signal and a second bone conduction signal, the first machine-learning model, where the second acoustic signal is captured using a first sensor included in a second device and the second bone conduction signal is captured using a second sensor included in the second device and where the first device and the second device are the same device model.

In aspects, the one or more processors are further configured to: receive, using a sensor included in a second device, the first acoustic signal, where the first device and the second device are the same device model.

Aspects of the present disclosure provide a non-transitory computer-readable medium including computer-executable instructions that, when executed by one or more processors of a first audio device, cause the first audio device to perform a method. The method generally includes: (i) inputting a first acoustic signal into a first machine-learning model, (ii) generating, with the first machine-learning model, a first bone conduction signal in a time domain or a spectral domain based, at least in part, on the first acoustic signal, (iii) generating, with the first machine-learning model, a transfer function that characterizes a relationship between the first acoustic signal and the first bone conduction signal based, at least in part, on the first acoustic signal, and (iv) training, using at least one of the first bone conduction signal or the transfer function, a second machine-learning model on a second device.

In aspects, the method further includes: (i) inputting a second acoustic signal captured using a first sensor included in the first device into the second machine-learning model, (ii) inputting a second bone conduction signal captured using a second sensor included in the first device into the second machine-learning model, and (iii) enhancing or suppressing, on the first device and using the second machine-learning model, speech from a user of the first device present in at least one of the second acoustic signal or the second bone conduction signal.

In aspects, the method further includes: training, using a second acoustic signal and a second bone conduction signal, the first machine-learning model, where the second acoustic signal is captured using a first sensor included in a second device and the second bone conduction signal is captured using a second sensor included in the second device and where the first device and the second device are the same device model.

In aspects, the method further includes: receiving, using a sensor included in a second device, the first acoustic signal, where the first device and the second device are the same device model.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 illustrates an example system, in which aspects of the present disclosure may be implemented.

FIG. 2 illustrates an exemplary wireless audio device, in which aspects of the present disclosure may be implemented.

FIG. 3 illustrates example wearable audio device operations, according to certain aspects of the present disclosure.

FIGS. 4A and 4B are block diagrams of example process flows for synthesizing bone conducted speech during the operations of FIG. 3, according to certain aspects of the present disclosure.

Like numerals indicate like elements.

### DETAILED DESCRIPTION

Certain aspects of the present disclosure provide techniques, including wearable audio devices and systems implementing the techniques, for synthesizing bone conducted speech. Such techniques may include (i) inputting a first acoustic signal (e.g., captured using an outside sensor) into a first machine-learning model, (ii) generating, with the first machine-learning model, a first bone conduction signal in a time domain or a spectral domain based, at least in part, on the first acoustic signal, (iii) generating, with the first machine-learning model, a transfer function that characterizes a relationship between the first acoustic signal and the first bone conduction signal based, at least in part, on the first acoustic signal, and (iv) training, using at least one of the first bone conduction signal or the transfer function, a second machine-learning model on a first audio device. In some cases, the inputting of the first acoustic signal into the first machine-learning model, the generating of the first bone conduction signal, and the generating of the transfer function may be performed using a second audio device, and the training of the second machine-learning model may be performed using the first audio device or the second audio device. In this manner, bone conduction signals (e.g., bone conducted speech (BCS)) may be synthesized from acoustic signals (e.g., using the first machine-learning model), and the synthesized bone conduction signals may be used to train a second machine-learning model on other devices to more effectively enhance and/or suppress the presence of speech in bone-conduction signals and/or acoustic signals (e.g., by changing the signal-to-noise (SNR) ratio of the signal(s)).

BCS is a phenomenon in which the vibrations generated by human speech are transmitted through the bones of the skull and tissues in the head of a person (e.g., a user) using (e.g., wearing) a wearable device. Modern wearable audio devices, such as headphones or earbuds, may contain one or more acoustic sensors and/or one or more bone conduction sensors (e.g., vibration sensors). The bone conduction sensors may be implemented by an internal microphone inside an ear canal of a user of the device, an internal microphone facing the ear canal on an around ear device, a voice band accelerometer outside the ear canal, a vibration accelerometer, a voice pickup unit (VPU), a feedback microphone, an inertial measurement unit (IMU), or the like. The acoustic sensors may capture airborne signals, such as airborne speech from a user, and the bone conduction sensors may capture bone conduction signals, such as BCS from the user. The relationship between the airborne acoustic signals and the bone conduction signals captured by a wearable device may be characterized by a nonlinear, time-varying, user-specific, device specific transfer function, where the time-variation is due to movements of the user of the wearable audio device (e.g., due to jaw, head, and/or body movements while the user is speaking).

BCS and airborne speech are different types of signals with different properties. For example, while the frequency response of BCS may be degraded in comparison to airborne speech, BCS exhibits other characteristics such as resilience to noise (e.g., as a result of passive acoustics of an audio device and/or active acoustics of the audio device, such as active noise reduction (ANR)) that may be important to the function of multimodal speech processing systems in wearable audio devices for tasks such as voice communications, augmented hearing, voice commands, or user identification. It is to be understood that airborne speech may, in some cases, include a relatively small amount of BCS. Multimodal systems may be capable of using both airborne speech and BCS for speech processing. These multimodal speech processing systems may be implemented using machine-learning models trained to produce clean speech from noisy BCS and/or noisy airborne speech signals. While a large corpora of airborne speech exists for the purpose of training machine-learning models for multimodal speech processing, there is a relative paucity of BCS corpora.

Obtaining BCS for training machine-learning models for use in multimodal speech processing systems may often involve relatively expensive and time-consuming data collection. In some cases, a relatively large amount of users (e.g., 50 or more people) may be gathered and each spend time in a specialized location (e.g., an anechoic chamber) doing various precise measurements of self-speech for a specific audio device model, such that a library of BCS may be generated and used to train machine-learning models for multimodal speech processing. This expensive and time-consuming data collection is often the primary bottleneck for developing multimodal speech processing systems for audio devices (e.g., wearable audio devices), especially as different audio devices have different designs/configurations and characteristics (e.g., acoustics), and therefore typically benefit from BCS collected specifically using a particular audio device model. The transfer function between airborne speech (e.g., captured with an outside sensor of an audio device) and BCS (e.g., captured with an internal sensor of the audio device) may be nonlinear, time-varying, user-specific, and/or device model-specific. As such, each audio device model that will utilize a machine-learning model for use in multimodal speech processing systems may usually use its own unique set of BCS data for training machine-learning models for use in multimodal speech processing systems.

The present disclosure may enable a first machine-learning model to predict (e.g., synthesize) bone conduction signal (e.g., BCS) data using only airborne speech (e.g., captured using an outside sensor), to enable BCS to be more easily and cheaply produced and subsequently used to trained a second machine-learning model in an audio device for multimodal speech processing. The first machine-learning model may be trained (e.g., conditioned) using a relatively small set of BCS data (e.g., one or two captured bone conduction signals that include BCS), learned embedding from the audio device (or the same model or type of audio device that will utilize the second machine-learning model) or a user of the audio device, and/or another conditioning vector. As a result, the present disclosure may enable the second machine-learning model for multimodal speech processing to be trained without expensive and time-consuming BCS collection. By using both airborne speech and BCS as inputs in the second machine-learning model for multimodal speech processing, the second machine-learning model may be able to more effectively enhance and/or reject speech (e.g., user self-speech). In this manner, denoising (e.g., during voice communication, such as phone calls, where using BCS may enable better enhancement of speech), aware modes (e.g., where using BCS may enable better removal of user self-speech, thereby eliminating (or at least reducing) latency caused by users hearing their own self-speech), extended reality (XR) applications (e.g., augmented reality (AR), virtual reality (VR), or mixed reality (MR) devices, where using BCS may enable better removal of user self-speech, while speech from others in the environment of the user is enhanced), as well as voice commands, voice interactions, and user identification/verification (e.g., which all may rely on accurate recognition of the user self-speech and/or the acoustics of the ear(s) of the user as a biometric verification to unlock the device) that involve using the second machine-learning model may all be significantly improved.

### An Example System

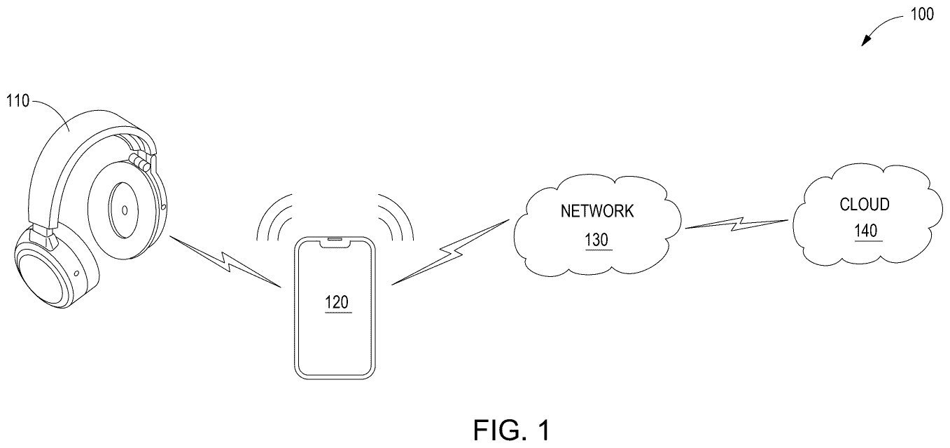

FIG. 1 illustrates an example system 100, in which aspects of the present disclosure may be implemented. As shown, system 100 includes one or more sound processing and playback devices 110 (e.g., a wireless audio device, such as a wearable device as shown in FIG. 1) communicatively coupled with a source device 120 (e.g., a computing device or user device, such as a smartphone, tablet, computer, television, and the like). Throughout the present disclosure, the sound processing and playback device 110 may be referred to simply as the wearable device 110. The wearable device 110 may be configured to be worn by a user and may be a headset that includes two or more speakers and two or more sensors, as illustrated in FIG. 1. The source device 120 is illustrated as a smartphone or a tablet computer wirelessly paired with the wearable device 110. At a high level, the wearable device 110 may play audio content transmitted from the source device 120. The user may use the graphical user interface (GUI) on the source device 120 to select the audio content and/or adjust settings of the wearable device 110. The wearable device 110 provides soundproofing, active noise cancellation, and/or other audio enhancement features to play the audio content transmitted from the source device 120.

In certain aspects, the wearable device 110 includes voice activity detection (VAD) circuitry capable of detecting the presence of speech signals (e.g., human speech signals) in a sound signal received by sensors (not illustrated) of the wearable device 110. For instance, the sensors of the wearable device 110 may be implemented as microphones and may receive ambient and external sounds in the vicinity of the wearable device 110, including speech uttered by the user. The sound signal received by the sensors may have the speech signal mixed in with other sounds in the vicinity of the wearable device 110. Using the VAD circuitry, the wearable device 110 may detect and extract the speech signal from the received sound signal. In certain aspects, the VAD circuitry may be used to detect and extract speech uttered by the user in order to facilitate a voice call, voice chat between the user and another person, or voice commands for a virtual personal assistant (VPA), such as a cloud based VPA. In some cases, detections or triggers can include self-VAD circuitry (only starting up when the user is speaking, regardless of whether others in the area are speaking), active transport (sounds captured from transportation systems), head gestures, buttons, computing device based triggers (e.g., pause/un-pause from the phone), changes with input audio level, and/or audible changes in environment, among others.

In certain aspects, the wearable device 110 includes speaker identification circuitry capable of detecting an identity of a speaker to which a detected speech signal relates to. For example, the speaker identification circuitry may analyze one or more characteristics of a speech signal detected by the VAD circuitry and determine that the user of the wearable device 110 is the speaker. In certain aspects, the speaker identification circuitry may use any of the existing speaker recognition methods and related systems to perform the speaker recognition.

The wearable device 110 further includes hardware and circuitry including processor(s)/processing system and memory configured to implement one or more sound management capabilities or other capabilities including, but not limited to, noise canceling circuitry (not shown) and/or noise masking circuitry (not shown), body movement detecting devices/sensors and circuitry (e.g., one or more accelerometers, one or more gyroscopes, one or more magnetometers, etc.), geolocation circuitry and other sound processing circuitry. The noise cancelling circuitry is configured to reduce unwanted ambient sounds external to the wearable device 110 by using active noise cancelling (also known as active noise reduction). The sound masking circuitry is configured to reduce distractions by playing masking sounds via the speakers of the wearable device 110. The movement detecting circuitry is configured to use devices/sensors such as an accelerometer, gyroscope, magnetometer, and the like to detect whether the user wearing the wearable device 110 is moving (e.g., walking, running, in a moving mode of transport, etc.) or is at rest and/or the direction the user is looking or facing. The movement detecting circuitry may also be configured to detect a head position of the user for use in determining an event, as well as in augmented reality (AR) applications where an AR sound is played back based on a direction of gaze of the user.

In certain aspects, the wearable device 110 is wirelessly connected to the source device 120 using one or more wireless communication methods including, but not limited to, Bluetooth, Wi-Fi, Bluetooth Low Energy (BLE), other radio frequency (RF) based techniques, and the like. In certain aspects, the wearable device 110 includes a transceiver that transmits and receives data via one or more antennae in order to exchange audio data and other information with the source device 120.

In certain aspects, the wearable device 110 includes communication circuitry capable of transmitting and receiving audio data and other information from the source device 120. The wearable device 110 also includes an incoming audio buffer, such as a render buffer, that buffers at least a portion of an incoming audio signal (e.g., audio packets) in order to allow time for retransmissions of any missed or dropped data packets from the source device 120. For example, when the wearable device 110 receives Bluetooth transmissions from the source device 120, the communication circuitry typically buffers at least a portion of the incoming audio data in the render buffer before the audio is actually rendered and output as audio to at least one of the transducers (e.g., audio speakers) of the wearable device 110. This is done to ensure that even if there are RF collisions that cause audio packets to be lost during transmission, there is time for the lost audio packets to be retransmitted by the source device 120 before the lost audio packets have been rendered by the wearable device 110 for output by one or more acoustic transducers of the wearable device 110.

The wearable device 110 is illustrated as over-the-head headphones; however, the techniques described herein apply to other wearable devices, such as wearable audio devices, including any audio output device that fits around, on, in, or near an ear (including open-ear audio devices worn on the head or shoulders of a user) or other body parts of a user, such as head or neck. The wearable device 110 may take any form, wearable or otherwise, including standalone devices (including automobile speaker system), stationary devices (including portable devices, such as battery powered portable speakers), headphones (including over-ear headphones, on-ear headphones, in-ear headphones), earphones, earpieces, headsets (including virtual reality (VR) headsets and AR headsets), goggles, headbands, earbuds, armbands, sport headphones, neckbands, hearing aids, or eyeglasses. In certain aspects, the wearable device 110 may be implemented as a banded headset with two cups each configured to deliver audio output.

In certain aspects, the wearable device 110 is connected to the source device 120 using a wired connection, with or without a corresponding wireless connection. The source device 120 may be a smartphone, a tablet computer, a laptop computer, a digital camera, or other computing device that connects with the wearable device 110. As shown, the source device 120 can be connected to a network 130 (e.g., the Internet) and may access one or more services over the network. As shown, these services can include one or more cloud 140 services.

In certain aspects, the source device 120 can access a cloud server in the cloud 140 over the network 130 using a mobile web browser or a local software application or “app” executed on the source device 120. In certain aspects, the software application or “app” is a local application that is installed and runs locally on the source device 120. In certain aspects, a cloud server accessible on the cloud 140 includes one or more cloud applications that are run on the cloud server. The cloud application may be accessed and run by the source device 120. For example, the cloud application can generate web pages that are rendered by the mobile web browser on the source device 120. In certain aspects, a mobile software application installed on the source device 120 or a cloud application installed on a cloud server, individually or in combination, may be used to implement the techniques for low latency Bluetooth communication between the source device 120 and the wearable device 110 in accordance with aspects of the present disclosure. In certain aspects, examples of the local software application and the cloud application include a gaming application, an audio AR or VR application, and/or a gaming application with audio AR or VR capabilities. The source device 120 may receive signals (e.g., data and controls) from the wearable device 110 and send signals to the wearable device 110.

### An Example Wearable Device

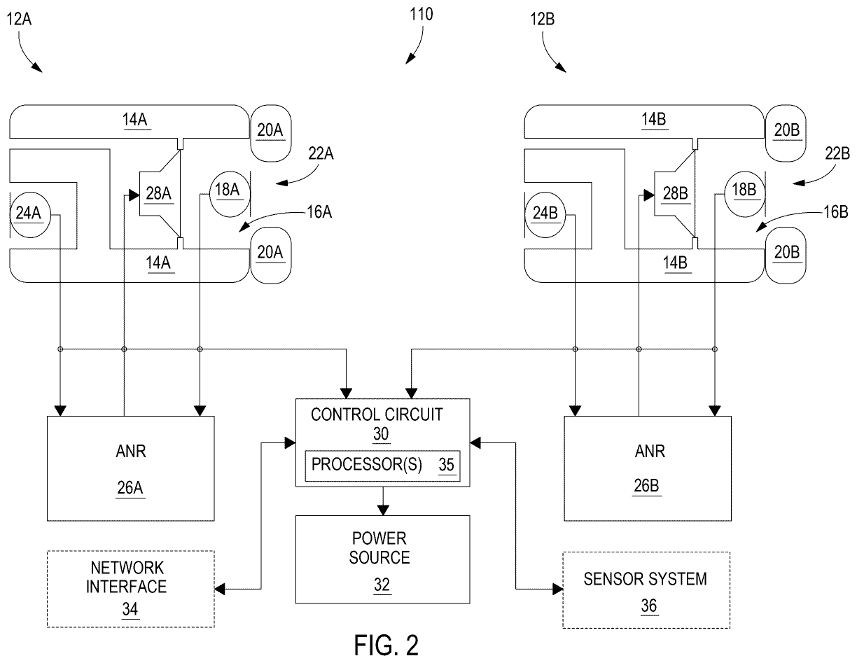

FIG. 2 illustrates an exemplary wearable device 110 and some of its components, in which aspects of the present disclosure may be implemented. Other components may be inherent in the wearable device 110 and not shown in FIG. 2. As shown, the wearable device 110 includes two earpieces 12A and 12B, each configured to direct sound towards an ear of the user. Reference numbers appended with an “A” or a “B” indicate a correspondence of the identified feature with a particular one of the earpieces 12 (e.g., a left earpiece 12A and a right earpiece 12B). Each earpiece 12 includes a casing 14 that defines a cavity 16. In some examples, one or more inner (e.g., internal) sensors 18 (e.g., inner microphone(s)) may be disposed within cavity 16. In implementations where the wearable device 110 is ear-mountable, an ear coupling 20 (e.g., an ear tip or ear cushion) may be attached to the casing 14 and surround an opening to the cavity 16. A passage 22 is formed through the ear coupling 20 and communicates with the opening to the cavity 16. In some examples, one or more outer sensors 24 are disposed on the casing in a manner that permits acoustic coupling to the environment external to the casing. The inner sensor(s) 18 and the outer sensor(s) 24 may each be implemented and/or referred to as a microphone, an accelerometer, and/or an inertial measurement unit (IMU).

In implementations that include active noise reduction (ANR) (which may include or be referred to as active noise cancellation (ANC), controllable noise canceling (CNC), and/or transparency (e.g., aware) mode operation (where environmental sound is sensed and then reproduced to the user so the user is more environmentally aware and can hear others speaking and the like)), the inner sensor(s) 18 may be an internal microphone(s) or feedback microphone(s) and the outer sensor(s) 24 may be feedforward microphone(s). In such implementations, each earpiece 12 includes an ANR circuit 26 that is in communication with the inner sensor(s) 18 and the outer sensor(s) 24. The ANR circuit 26 receives an inner signal generated by the inner sensor(s) 18 and an outer signal generated by the outer sensor(s) 24 and performs an ANR process for the corresponding earpiece 12. The process includes providing a signal to an electroacoustic transducer 28 (e.g., speaker) disposed in the cavity 16 to generate an anti-noise acoustic signal that reduces or substantially prevents sound from one or more acoustic noise sources that are external to the earpiece 12 from being heard by the user. In addition to providing an anti-noise acoustic signal, the electroacoustic transducer 28 may utilize its sound-radiating surface for providing an audio output for playback (e.g., for a continuous audio feed).

In certain aspects, the wearable device 110 may also include a control circuit 30. The control circuit 30 is in communication with the inner sensor(s) 18, outer sensor(s) 24, and electroacoustic transducers 28, and receives the inner and/or outer microphone signals. In some cases, the control circuit 30 includes one or more microcontroller(s) or processor(s) 35, including for example, a digital signal processor (DSP) and/or an advanced reduced instruction set computer (RISC) machine (ARM) chip. In some cases, the microcontroller(s)/processor(s) (or simply, processor(s)) 35 may include multiple chipsets for performing distinct functions. For example, the processor(s) 35 may include a DSP chip for performing music and voice related functions, and a co-processor such as an ARM chip (or chipset) for performing sensor related functions. In certain aspects, the control circuit 30 may be configured to calculate an equalization (EQ) controller, an ANR controller, a transparency mode controller, and/or other controllers (and/or filters) used to control various operations of the wearable device 110 based on an estimated audio transfer function between the electroacoustic transducer 28 and the inner sensor(s) 18.

The control circuit 30 may also include analog to digital converters for converting the inner signals from the two inner sensors 18 and/or the outer signals from the two outer sensors 24 to digital format. In response to the received inner and/or outer microphone signals, the control circuit 30 (including processor(s) 35) may take various actions. For example, audio playback may be initiated, paused, or resumed, a notification to a user (e.g., wearer) may be provided or altered, and a device (e.g., a cellular phone, a handheld device, a wireless device, a laptop computer, a tablet, a smartphone, an Internet of things (IoT) device, a wearable device, an AR device, a VR device, etc.) in communication with the wearable device 110 may be controlled. The wearable device 110 may also include a power source 32. The control circuit 30 and power source 32 may be in one or both of the earpieces 12 or may be in a separate housing in communication with the earpieces 12. The wearable device 110 may also include a network interface 34 to provide communication between the wearable device 110 and one or more audio sources or other personal audio devices (e.g., source device 120 as illustrated in FIG. 1). The network interface 34 may be wired (e.g., Ethernet) or wireless (e.g., employ a wireless communication protocol such as IEEE 802.11, Bluetooth, Bluetooth Low Energy (BLE), or other local area network (LAN) or personal area network (PAN) protocols).

The network interface 34 is shown in phantom, as portions of the network interface 34 may be located remotely from the wearable device 110. The network interface 34 may provide for communication between the wearable device 110, audio sources, and/or other networked (e.g., wireless) speaker packages and/or other audio playback devices via one or more communications protocols. The network interface 34 may provide either or both of a wireless interface and a wired interface. The wireless interface may allow the wearable device 110 to communicate wirelessly with other devices in accordance with any communication protocol noted herein. In some particular cases, a wired interface may be used to provide network interface functions via a wired (e.g., Ethernet) connection.

In certain aspects, the network interface 34 may also include one or more network media processor(s) for supporting, e.g., Apple AirPlay® (a proprietary protocol stack/suite developed by Apple Inc., with headquarters in Cupertino, Calif., that allows wireless streaming of audio, video, and photos, together with related metadata between devices) or other known wireless streaming services (e.g., an Internet music service such as: Pandora®, a radio station provided by Pandora Media, Inc. of Oakland, Calif., USA; Spotify®, provided by Spotify USA, Inc., of New York, N.Y., USA); or vTuner®, provided by vTuner.com of New York, N.Y., USA); and network-attached storage (NAS) devices). For example, when a user connects an AirPlay® enabled device, such as an iPhone or iPad device, to the network, the user may then stream music to the network connected audio playback devices via Apple AirPlay®. Notably, the audio playback device can support audio-streaming via AirPlay® and/or DLNA's UPnP protocols, and all integrated within one device. Other digital audio coming from network packets may come straight from the network media processor(s) through (e.g., through a USB bridge) to the control circuit 30. As noted herein, in some cases, the control circuit 30 may include one or more processor(s) and/or microcontroller(s) (simply, “processor(s)” 35), which can include decoders, digital signal processors (DSPs) hardware/software, ARM processor(s) hardware/software, etc. for playing back (rendering) audio content at electroacoustic transducers 28. In some cases, the network interface 34 may also include Bluetooth circuitry for Bluetooth applications (e.g., for wireless communication with a Bluetooth enabled audio source such as a smartphone or tablet). In operation, streamed data can pass from the network interface 34 to the control circuit 30, including the processor(s) or microcontroller(s) (e.g., processor(s) 35). The control circuit 30 may execute instructions (e.g., for performing, among other things, digital signal processing, decoding, and equalization functions), including instructions stored in a corresponding memory (which may be internal to control circuit 30 or accessible via network interface 34 or other network connection (e.g., cloud-based connection). The control circuit 30 may be implemented as a chipset of chips that include separate and multiple analog and digital processors. The control circuit 30 may provide, for example, for coordination of other components of the wearable device 110, such as control of user interfaces (not shown) and applications run by the wearable device 110.

In addition to a processor(s) and/or microcontroller(s), control circuit 30 may also include one or more digital-to-analog (D/A) converters for converting the digital audio signal to an analog audio signal. This audio hardware may also include one or more amplifiers which provide amplified analog audio signals to the electroacoustic transducer(s) 28, which each include a sound-radiating surface for providing an audio output for playback. In addition, the audio hardware may include circuitry for processing analog input signals to provide digital audio signals for sharing with other devices.

The memory in control circuit 30 may include, for example, flash memory and/or non-volatile random access memory (NVRAM). In some implementations, instructions (e.g., software) are stored in an information carrier. The instructions, when executed by one or more processing devices (e.g., the processor(s) or microcontroller(s) in control circuit 30), perform one or more processes, such as those described elsewhere herein. The instructions can also be stored by one or more storage devices, such as one or more (e.g., non-transitory) computer or machine-readable mediums (for example, the memory, or memory on the processor(s)/microcontroller(s)). As described herein, the control circuit 30 (e.g., memory, or memory on the processor(s)/microcontroller(s)) may include a control system including instructions for controlling directional audio selection functions according to various particular implementations. It is understood that portions of the control circuit 30 (e.g., instructions) could also be stored in a remote location or in a distributed location and could be fetched or otherwise obtained by the control circuit 30 (e.g., via any communications protocol described herein) for execution. The instructions may include instructions for controlling device functions based upon detected don/doff events (i.e., the software modules include logic for processing inputs from a sensor system to manage audio functions), as well as digital signal processing and equalization.

The wearable device 110 may also include a sensor system 36 coupled with control circuit 30 for detecting one or more conditions of the environment proximate the wearable device 110. The sensor system 36 may include inner sensor(s) 18 and/or outer sensors 24, sensors for detecting inertial conditions at the personal audio device, and/or sensors for detecting conditions of the environment proximate the wearable device 110, as described herein. Sensor system 36 may also include one or more proximity sensors, such as a capacitive proximity sensor or an IR sensor, and/or one or more optical sensors.

The sensors may be on-board the wearable device 110 or may be remote or otherwise wirelessly (or hard-wired) connected to the wearable device 110. As described further herein, the sensor system 36 may include a plurality of distinct sensor types for detecting proximity information, inertial information, environmental information, or commands at the wearable device 110. In particular implementations, the sensor system 36 may enable detection of user movement, including movement of a user's head or other body part(s). Portions of the sensor system 36 may incorporate one or more movement sensors, such as accelerometers, gyroscopes and/or magnetometers and/or a single inertial measurement unit (IMU) having three-dimensional (3D) accelerometers, gyroscopes and a magnetometer.

In various implementations, the sensor system 36 can be located at the wearable device 110 (e.g., where a proximity sensor is physically housed in the wearable device 110). In some examples, the sensor system 36 is configured to detect a change in the position of the wearable device 110 relative to the user's head (e.g., detect the device operating state). Data indicating the change in the position of the wearable device 110 may be used to trigger a command function, such as activating an operating mode of the wearable device 110, modifying playback of audio at the wearable device 110 (e.g., by modifying the audio noise reduction (ANR), or transparency of the wearable device), or controlling a power function of the wearable device 110.

The sensor system 36 may also include one or more interface(s) for receiving commands at the wearable device 110. For example, the sensor system 36 may include an interface permitting a user to initiate functions of the wearable device 110. In a particular example implementation, the sensor system 36 may include, or be coupled with, a capacitive touch interface for receiving tactile commands on the wearable device 110.

In other implementations, as illustrated in the phantom depiction in FIG. 2, one or more portions of the sensor system 36 may be located at another device capable of indicating movement and/or inertial information about the user of the wearable device 110. For example, in some cases, the sensor system 36 may include an IMU physically housed in a hand-held device such as a smart device (e.g., smart phone, tablet, etc.) a pointer, or in another wearable audio device. In particular example implementations, at least one of the sensors in the sensor system 36 may be housed in a wearable audio device distinct from the wearable device 110, such as where wearable device 110 includes headphones and an IMU is located in a pair of glasses, a watch, or other wearable electronic device.

In certain aspects, the control circuit 30 is in communication with the inner sensor(s) 18 and receives the two inner signals. Alternatively, the control circuit 30 may be in communication with the outer sensors 24 and receive the two outer signals. In another alternative, the control circuit 30 may be in communication with both the inner sensor(s) 18 and outer sensors 24 and receives the two inner and two outer signals. It should be noted that in some implementations, there may be multiple inner and/or outer microphones in each earpiece 12. As noted herein, the control circuit 30 may include one or more microcontroller(s) or processor(s) having a DSP and the inner signals from the two inner sensor(s) 18 and/or the outer signals from the two outer sensors 24 are converted to digital format by analog to digital converters. In response to the received inner and/or outer signals, the control circuit 30 may take various actions. For example, the power supplied to the wearable device 110 may be reduced upon a determination that one or both earpieces 12 are off-head. In another example, full power may be returned to the wearable device 110 in response to a determination that at least one earpiece becomes on head. Other aspects of the wearable device 110 may be modified or controlled in response to determining that a change in the operating state of the earpiece 12 has occurred. For example, ANR functionality may be enabled or disabled, audio playback may be initiated, paused or resumed, a notification to a wearer may be altered, and a device (e.g., a cellular phone, a handheld device, a wireless device, a laptop computer, a tablet, a smartphone, an Internet of things (IoT) device, a wearable device, an AR device, a VR device, etc.) in communication with the wearable device 110 may be controlled. As illustrated, the control circuit 30 generates a signal that is used to control a power source 32 for the wearable device 110. The control circuit 30 and power source 32 may be in one or both of the earpieces 12 or may be in a separate housing in communication with the earpieces 12.

### Example Operations for Synthesizing Bone Conducted Speech

Certain aspects of the present disclosure provide techniques, including wearable audio devices and systems implementing the techniques, for synthesizing bone conduction signals from acoustic signals (e.g., using a first machine-learning model) on an audio device, and using the synthesized bone conduction signals to train a second machine-learning model on downstream audio devices to improve multimodal speech processing. In this manner, the second machine-learning model may more effectively enhance and/or suppress the presence of speech in bone-conduction signals and/or acoustic signals (e.g., by changing the signal-to-noise (SNR) ratio).

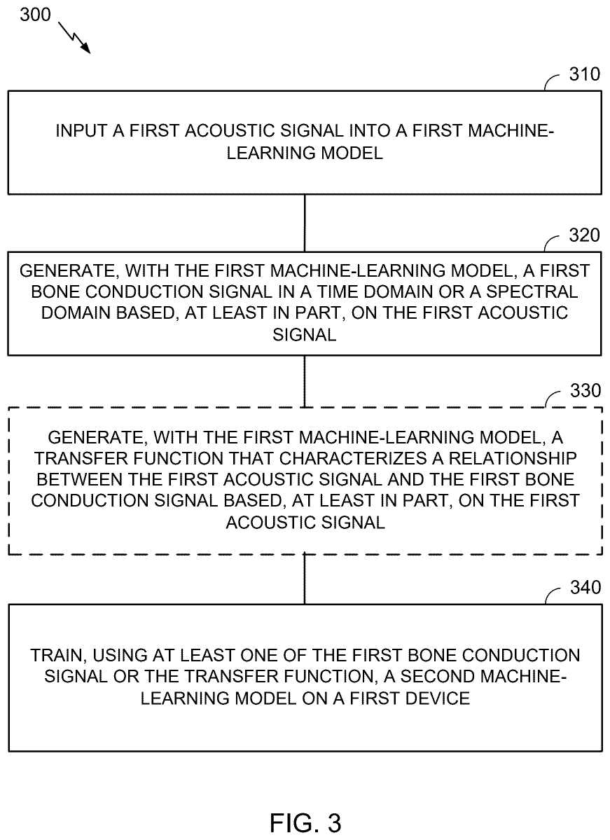

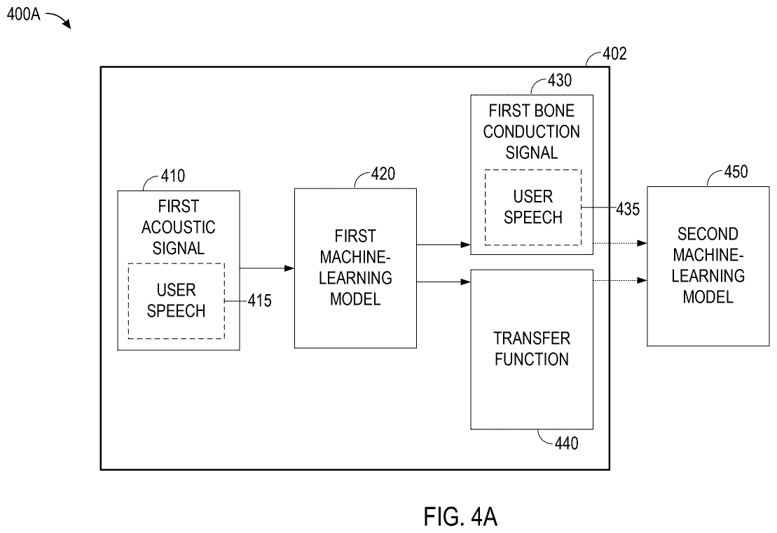

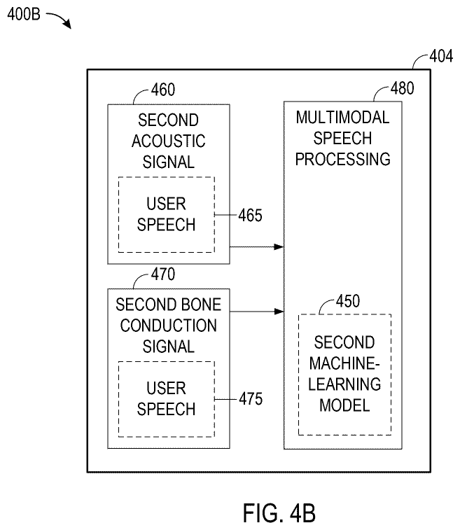

FIG. 3 illustrates example wearable audio device operations 300, according to certain aspects of the present disclosure. FIGS. 4A and 4B are block diagrams of example process flows 400A and 400B for synthesizing bone conducted speech during the operations of FIG. 3, according to certain aspects of the present disclosure. Therefore, FIGS. 3, 4A, and 4B are herein described together for clarity. In certain aspects, at least part of the operations 300 and at least part of the process flows 400A and 400B may be performed by one or more audio devices (e.g., the wearable device 110 of FIG. 1, the source device 120 of FIG. 1), or by control circuits (e.g., control circuit 30) of the one or more audio devices (e.g., using one or more processors, individually or collectively, included in the control circuit 30). For example, at least part of the operations 300 and the process flows 400A and 400B may be performed by the at least one processor(s) 221 included in the device 110 (e.g., as illustrated in FIG. 1). In some cases, the process flow 400A and part of the operations 300 may be performed by one or more first audio devices 402 (e.g., the wearable device 110 of FIG. 1 and/or the source device 120 of FIG. 1), or by control circuits (e.g., control circuit 30) of the one or more first audio devices 402 (e.g., using one or more processors, individually or collectively, included in the control circuit 30), and the process flow 400B and part of the operations 300 may be performed by one or more second audio devices 404 (e.g., a downstream device, such as another wearable device 110), or by control circuits (e.g., control circuit 30) of the one or more second audio devices 404 (e.g., using one or more processors, individually or collectively, included in the control circuit 30).

The operations 300 may include, at block 310, inputting a first acoustic signal 410 into a first machine-learning model 420. The first acoustic signal 410 may be received at the first audio device 402 (e.g., the wearable device 110 of FIG. 1). For example, the first acoustic signal 410 may be received at a first sensor (e.g., an outside sensor or acoustic sensor, such as a microphone located outside of the first audio device 402) included in the first audio device 402. In some cases, the first acoustic signal 410 may include speech from the user of the first audio device 402 (hereinafter referred to as user speech 415).

According to certain aspects, and prior to block 310, the operations 300 may further include training, using one or more acoustic signals and/or one or more bone conduction signals, the first machine-learning model 420. In some cases, the one or more acoustic signals may be captured using a first sensor (e.g., an acoustic sensor) included in the first audio device 402 and the one or more bone conduction signals may be captured using a second sensor (e.g., a bone conduction sensor and/or transducer) included in the first audio device 402, whereas in other cases, the one or more acoustic signals and/or the one or more bone conduction signals may be captured by and provided from another device. The bone conduction sensors and/or transducers may be implemented by an internal microphone inside an ear canal of a user of the first audio device 402, an internal microphone facing the ear canal on an around ear audio device, a voice band accelerometer outside the ear canal, a vibration accelerometer, a voice pickup unit (VPU), a feedback microphone, inertial measurement unit (IMU), or the like. The one or more acoustic signals and/or the one or more bone conduction signals may be captured in noisy environments and/or quiet environments and subsequently used to train the first machine-learning model 420 for generating the first bone conduction signal at block 320 and/or the transfer function at block 330 for training the second machine-learning model 450 for multimodal speech processing 480.

In certain aspects, the first machine-learning model 420 may be trained (e.g., conditioned) using a relatively small number of the one or more acoustic signals and corresponding one or more bone conduction signals from a few users. In some cases, the second machine-learning model 450 may also be trained (e.g., conditioned) using a relatively small number of the one or more acoustic signals and the corresponding one or more bone conduction signals. The first machine-learning model 420 and/or the second machine-learning model 450 may be trained and updated using additional acoustic signals and corresponding bone conduction signals. In this manner, the first machine-learning model 420 may continue to be updated to improve the operations 300 at block 320 and block 330, and/or the second machine-learning model 450 may continue to be updated to improve multimodal speech processing 480 performance.

In certain aspects, the other device which provides the one or more acoustic signals and/or the one or more bone conduction signals may be the same device model as the first audio device 402 where block 310 is performed. In this manner, the operations 300 may confirm that the first audio device is the same model (e.g., having the same designs/configurations and/or acoustics) as the second audio device 404, to ensure that the appropriate bone conduction signal and/or transfer function is used among audio devices that are the same model.

At block 320, the operations 300 may include generating, with the first machine-learning model 420, a first bone conduction signal 430 in a time domain or a spectral domain based, at least in part, on the first acoustic signal 410. The first bone conduction signal 430 may include user speech 435 (which corresponds to the user speech 415 in the first acoustic signal 410). In this manner, the first bone conduction signal 430 may be synthesized from the first acoustic signal 410 using the first machine-learning model 420. It is to be understood that the user speech 415 and the user speech 435 represent the same user speech, but may be different signals because the user speech 415 is the user speech represented in an acoustic signal (e.g., the first acoustic signal 410) and the user speech 435 is the user speech represented in a bone conduction signal (e.g., the first bone conduction signal 430).

At block 330, the operations 300 may optionally include generating, with the first machine-learning model 420, a transfer function 440 that characterizes a relationship between the first acoustic signal 410 and the first bone conduction signal 430 based, at least in part, on the first acoustic signal 410. In some cases, the transfer function may be a dynamic, nonlinear, time-varying, user-specific, and/or device model-specific estimation.

In certain aspects, generating the first bone conduction signal 430 in the time domain or the spectral domain based, at least in part, on the first acoustic signal 410 at block 320 includes using time-domain mapping and/or filtering, real spectral mapping and/or filtering, complex spectral mapping and/or filtering, and/or latent mapping and/or filtering. In these aspects, generating the transfer function 440 may be based, at least in part, on the first acoustic signal 410 at block 330 includes using real spectral mapping and/or filtering, complex spectral mapping and/or filtering, and/or latent mapping and/or filtering. It is to be understood that these techniques (e.g., time-domain mapping and/or filtering, real spectral mapping and/or filtering, complex spectral mapping and/or filtering, and latent mapping and/or filtering) may each involve mapping and/or filtering. In this manner, the first machine-learning model 420, which may be trained using a relatively small number of acoustic signals and/or bone conduction signals, may be used to generate the first bone conduction signal 430 using the first acoustic signal 410. These aspects may involve or be understood to be the first machine-learning model 420 using direct mapping.

At block 340, the operations 300 may include training, using at least one of the first bone conduction signal 430 or the transfer function 440, a second machine-learning model 450 on the second audio device 404. It is to be understood that in some cases, only one of the first bone conduction signal 430 or the transfer function 440 may be used for the training at block 340. In certain aspects, the second audio device 404 may include or be implemented by a wearable device, such as the wearable device 110 of FIG. 1 (e.g., by a different wearable device than the first audio device). In this manner, the first bone conduction signal 430 and/or the transfer function 440 generated by the first audio device 402 may be used to train the second machine-learning model 450 (or models) on other audio devices (e.g., downstream audio devices) and/or in a cloud-based server to improve multimodal speech processing 480 (e.g., which enables improved denoising, aware modes, extended reality (XR) applications, as well as voice commands, voice interactions, and/or user identification/verification) on those audio devices, as described herein. In certain aspects, the training at block 340 may also involve using the first acoustic signal 410.

In some cases, the training, using at least one of the first bone conduction signal 430 or the transfer function 440, the second machine-learning model 450 on the second audio device 404 at block 340 may be performed by the first audio device 402. In other cases, the training, using at least one of the first bone conduction signal 430 or the transfer function 440, the second machine-learning model 450 on the second audio device 404 at block 340 may be performed by the second audio device 404 on itself (e.g., after the at least one of the first bone conduction signal 430 or the transfer function 440 are transmitted from the first audio device 402 to the second audio device 404). In certain aspects, instead of transmitting the at least one of the first bone conduction signal 430 or the transfer function 440 from the first audio device 402 to the second audio device 404, the first audio device 402 may train the second machine-learning model 450 of the second audio device 404 by conditioning the second machine-learning model 450 with invariant properties determined by the first machine-learning model 420, such a device vector characterizing the first audio device 402 (e.g., without directly transferring the at least one of the first bone conduction signal 430 or the transfer function 440 from the first audio device 402 to the second audio device 404). In this manner, the second machine-learning model 450 may receive as inputs the invariant properties determined by the first machine-learning model 420, an acoustic signal (e.g., a second acoustic signal 460), and a bone conduction signal (e.g., a second bone conduction signal 470), and perform the multimodal speech processing described herein.

In certain aspects, the first audio device 402 (which may perform blocks 310, 320, 330, and/or 340) and the second audio device 404 (which includes the second machine-learning model 450) are the same device model. In some cases, the operations 300 may confirm that the first audio device is the same model (e.g., having the same designs/configurations and/or acoustics) as the second audio device 404 before block 340, to ensure that the appropriate bone conduction signal and/or transfer function is used for training machine-learning models on audio devices that are the same model.

In certain aspects, when two devices used in the operations 300 are different models (e.g., having a different designs/configurations and/or acoustics), the information from a first device may used in conjunction with a machine learning model to estimate information about a second device. For example, the first device may be parameterized as, for example, a transfer function between an outside sensor of the first device and an inside sensor of the first device, speech from a user of the first device, or other ways. Then, the parameterized information from the first device may be used to estimate the transfer function of the second device based on the differences in the designs/configurations and/or acoustics of the first device and the second device. In some cases, parameterized information from the first device and one or more other devices may be used to generate/estimate the transfer function of the second device.

According to certain aspects, the operations 300 may further include (i) inputting the second acoustic signal 460 captured using a second sensor included in the second audio device 404 into the second machine-learning model 450, (ii) inputting the second bone conduction signal 470 captured using a third sensor included in the second audio device 404 into the second machine-learning model 450, and (iii) enhancing or suppressing, on the second audio device 404 and using the second machine-learning model 450, speech from a user of the second audio device 404 (hereinafter referred to as user speech 465) present in at least one of the second acoustic signal 460 or user speech 475 (which corresponds to the user speech 465 in the second acoustic signal 460) present in the second bone conduction signal 470. Any of the first acoustic signal 410, the first bone conduction signal 430, the second acoustic signal 460, or the second bone conduction signal 470 may include noise (e.g., ambient noise present in the environment surrounding the audio device). The noise may include, for example, one or more of speech from the other people present in the vicinity of the user of the audio device (e.g., the first audio device 402 or the second audio device 404), sneezing, crying, laughing, alarms, sirens, sound associated with transportation, household noise, and/or other ambient sounds present in the environment surrounding the audio device. Enhancing the user speech 465 in the second acoustic signal 460 may involve, for example, increasing the signal-to-noise ratio (SNR) of the user speech 465 (e.g., a ratio of the user speech 465 to the noise) in the second acoustic signal 460 (e.g., by increasing the user speech 465 in the second acoustic signal 460 and/or decreasing the noise (e.g., sound other than the user speech 465) in the in the second acoustic signal 460), while suppressing the user speech 465 in the second acoustic signal 460 may involve, for example, decreasing the SNR of the user speech 465 in the second acoustic signal 460 (e.g., by decreasing the user speech 465 in the second acoustic signal 460 and/or increasing the noise (e.g., sound other than the user speech 465) in the in the second acoustic signal 460). In this manner, the second machine-learning model 450 (which has been trained using the at least one of the first bone conduction signal 430 or the transfer function 440) may more effectively perform improved multimodal speech processing 480 (e.g., which enables improved denoising, aware modes, extended reality (XR) applications, as well as voice commands, voice interactions, and/or user identification/verification) on the second audio device 404.

The second sensor included in the second audio device 404 may be implemented as an acoustic sensor. The third sensor included in the second audio device 404 may include or be implemented by an internal sensor. The internal sensor may be implemented by a bone conduction sensor and/or transducer (e.g., a vibration sensor). For example, the internal sensor may be implemented by an internal microphone inside an ear canal of a user of the second audio device 404, an internal microphone facing the ear canal on an around ear device, a voice band accelerometer outside the ear canal, a vibration accelerometer, a voice pickup unit (VPU), a feedback microphone, an inertial measurement unit (IMU), or the like. It is to be understood that the user speech 465 and the user speech 475 represent the same user speech, but may be different signals because the user speech 465 is the user speech represented in an acoustic signal (e.g., the second acoustic signal 460) and the user speech 475 is the user speech represented in a bone conduction signal (e.g., the second bone conduction signal 470).

In certain aspects, the operations 300 may further include inputting the second acoustic signal 460 into the second machine-learning model 450 and enhancing or suppressing, on the second audio device 404 and using the second machine-learning model 450, the user speech 465 present in the second acoustic signal 460 without inputting the second bone conduction signal 470 into the second machine-learning model 450. In these aspects, the second audio device 404 may generate a second bone conduction signal (using the corresponding second acoustic signal 460) for performing multimodal speech processing 480 without the use of a bone conduction sensor to a capture a bone conduction signal. This may be especially beneficial in audio devices that may include one or more acoustic sensors, but may not include bone conduction sensors or transducers.

According to certain aspects, and in addition to the operations for the first machine-learning model 420 while using the direct mapping described above, the operations 300 may further include inputting at least one of a representation of the first audio device 402 or a representation of a user of the first audio device 402 into the first machine-learning model 420 (in addition to the first acoustic signal 410). In these aspects, generating the first bone conduction signal 430 at block 320 may be further based, at least in part, on the at least one of the representation of the first audio device 402 or the representation of the user of the first audio device 402, and generating the transfer function at block 330 may be further based, at least in part, on the at least one of the representation of the first audio device 402 or the representation of the user of the first audio device 402. The representation of the first audio device 402 and/or the representation of the user of the first audio device 402 may be latent representations or manually defined representations (e.g., implemented by vectors, such as a one-hot vector specific to the user of the first audio device and/or a one-hot vector specific to the first audio device 402). The representation of the first audio device 402 and/or the representation of the user of the first audio device 402 may be represented by vectors, such as one-hot vectors specific to the user of the first audio device 402 and/or one-hot vectors specific to the first audio device 402, produced by one or more pre-trained machine-learning models configured to characterize the user of the first audio device 402 and/or the first audio device 402 itself in a continuous latent space (using techniques such as self-supervised or metric learning), or directly learned during training from random initializations with the first machine-learning model 420.

In some cases, the representation of the first audio device 402 and/or the representation of the user of the first audio device 402 may be combined with additional representations of the first audio device 402 and/or representations of the user of the first audio device 402 (e.g., user vectors) post-hoc to generate the first bone conduction signal 430 and/or the transfer function 440. In some cases, the pre-trained-machine learning model may be an acoustic model such as a speech verification model conditioned using the first acoustic signal 410 which produces an embedding of a vector specific to the user, which may then be used to condition the first machine-learning model 420. These aspects may involve or be understood to be the first machine-learning model 420 using disentangled direct mapping (e.g., due to the disentangling of the user and/or device vector during the training of the first machine-learning model 420).

In certain aspects, and in addition to the operations for the first machine-learning model 420 while using the disentangled direct mapping described above, generating the transfer function 440 at block 330 based, at least in part, on the first acoustic signal 410 may include (i) using an encoder and a decoder both included in the first machine-learning model 420, and (ii) inputting the at least one of the representation of the first audio device 402 or the representation of the user of the first audio device 402 may include inputting the at least one of the representation of the first audio device 402 or the representation of the user of the first audio device 402 into the decoder. In this manner, the first machine-learning model 420 (e.g., the mapper) may have an encoder/decoder architecture, and the at least one of the representation of the first audio device 402 and/or the representation of the user of the first audio device 402 may be input into the decoder rather than the first machine-learning model 420 itself. These aspects may involve or be understood to be the first machine-learning model 420 using encoder/decoder disentangled direct mapping.

In certain aspects, inputting the first acoustic signal 410 into the first machine-learning model 420 may include inputting a linguistic input representing the first acoustic signal 410 into the first machine-learning model 420. In some cases, the linguistic input may be a text input and may be encoded in a multimodal latent space that includes text and/or audio using, for example, a contrastive language-audio pretraining architecture, whereas in other cases, the linguistic input may represent an input that includes a content representation, such as phonemes for generating the first bone conduction signal 430 and/or the transfer function 440. The linguistic input may also include the emotion, accent, age, demographic, and/or mood of the user of first audio device who originates the user speech 435. Utilizing the linguistic input with the first machine-learning model 420 may enable the second machine-learning model 450 to be better trained (e.g., at block 340) to identify key words (e.g., such as wake-up words) during multimodal speech processing 480. These aspects may involve or be understood to be the first machine-learning model 420 using text-conditioning.

In certain aspects, the first machine-learning model 420, the second machine-learning model 450, and/or any other machine-learning models described herein may include a neural network. In some cases, the first machine-learning model 420, the second machine-learning model 450, and/or any other machine-learning models may be trained machine-learning models and may be implemented by deep learning models. The first machine-learning model 420, the second machine-learning model 450, and/or any other machine-learning models may use various machine learning techniques based on artificial neural networks. For example, the first machine-learning model 420, the second machine-learning model 450, and/or any other machine-learning models, when implemented as deep learning models, may include deep learning architectures, such as deep neural networks, deep belief networks, deep reinforcement learning, recurrent neural networks, convolutional neural networks (e.g., temporal convolutional neural networks), latent diffusion, transformers, and the like.

In certain aspects, the operations described herein may be used to model the leakage of outside sounds (e.g., sound captured in the environment surrounding an audio device) to bone conduction sensors. In some cases, a first machine-learning model may receive a user of an audio devices' voice (e.g., self-speech, captured at one or more outside sensors) and an outside audio signal (e.g., captured at one or more outside sensors). The first machine-learning model may output the voice of the user of the audio devices at one or more bone conduction sensors and/or the outside audio signal at one or more bone conduction sensors. The user of the audio devices' voice at one or more bone conduction sensors and/or the outside audio signal at one or more bone conduction sensors may be summed for their respective outside sensors and bone conduction sensors to create a scene that may be used to train a second machine learning model for multimodal speech processing. The first machine-learning model trained in this manner may have better performance than other machine-learning models as a result of using the signals from both the outside sensors and the inside sensors during training.

It is to be understood that any of the operations described herein may be combined together in any combination. For example, any of the features described with respect to the direct mapping, the disentangled direct mapping, the encoder/decoder disentangled direct mapping, and/or the text-conditioning may be combined and performed together.

### ADDITIONAL CONSIDERATIONS

It is noted that, descriptions of aspects of the present disclosure are presented above for purposes of illustration, but aspects of the present disclosure are not intended to be limited to any of the disclosed aspects. Many modifications and variations will be apparent to those of ordinary skill in the art without departing from the scope and spirit of the described aspects.

In the preceding, reference is made to aspects presented in this disclosure. However, the scope of the present disclosure is not limited to specific described aspects. Aspects of the present disclosure can take the form of an entirely hardware aspect, an entirely software aspect (including firmware, resident software, micro-code, etc.) or an aspect combining software and hardware aspects that can all generally be referred to herein as a “component,” “circuit,” “module” or “system.” Furthermore, aspects of the present disclosure can take the form of a computer program product embodied in one or more computer readable medium(s) having computer readable program code embodied thereon.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples of a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium can be any tangible medium that can contain, or store a program.

The flowchart and block diagrams in the Figures illustrate the architecture, functionality and operation of possible implementations of systems, methods and computer program products according to various aspects. In this regard, each block in the flowchart or block diagrams can represent a module, segment or portion of code, which comprises one or more executable instructions for implementing the specified logical function(s). In some alternative implementations the functions noted in the block can occur out of the order noted in the figures. For example, two blocks shown in succession can, in fact, be executed substantially concurrently, or the blocks can sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

What is claimed is:

1. A method comprising:
inputting a first acoustic signal into a first machine-learning model;
generating, with the first machine-learning model, a first bone conduction signal in a time domain or a spectral domain based, at least in part, on the first acoustic signal;
generating, with the first machine-learning model, a transfer function that characterizes a relationship between the first acoustic signal and the first bone conduction signal based, at least in part, on the first acoustic signal; and
training, using at least one of the first bone conduction signal or the transfer function, a second machine-learning model on a first device.

2. The method of claim 1, further comprising:
inputting a second acoustic signal captured using a first sensor included in the first device into the second machine-learning model;
inputting a second bone conduction signal captured using a second sensor included in the first device into the second machine-learning model; and
enhancing or suppressing, on the first device and using the second machine-learning model, speech from a user of the first device present in at least one of the second acoustic signal or the second bone conduction signal.

3. The method of claim 1, further comprising:
training, using a second acoustic signal and a second bone conduction signal, the first machine-learning model, wherein the second acoustic signal is captured using a first sensor included in a second device and the second bone conduction signal is captured using a second sensor included in the second device and wherein the first device and the second device are the same device model.

4. The method of claim 1, further comprising:
receiving, using a sensor included in a second device, the first acoustic signal, wherein the first device and the second device are the same device model.

5. The method of claim 1, wherein the transfer function is nonlinear, time-varying, user-specific, and device model-specific.

6. The method of claim 1, wherein at least one of:
generating the first bone conduction signal in the time domain or the spectral domain based, at least in part, on the first acoustic signal comprises using real spectral mapping or filtering, complex spectral mapping or filtering, or latent mapping or filtering; or
generating the transfer function based, at least in part, on the first acoustic signal comprises using time-domain mapping or filtering, real spectral mapping or filtering, complex spectral mapping or filtering, or latent mapping or filtering.

7. The method of claim 1, further comprising:
inputting at least one of a representation of a second device or a representation of a user of the second device into the first machine-learning model, wherein:
generating the first bone conduction signal is further based, at least in part, on the at least one of the representation of the second device or the representation of the user of the second device; and
generating the transfer function is further based, at least in part, on the at least one of the representation of the second device or the representation of the user of the second device.

8. The method of claim 7, wherein:
generating the transfer function based, at least in part, on the first acoustic signal comprises using an encoder and a decoder both included in the first machine-learning model; and
inputting the at least one of the representation of the second device or the representation of the user of the second device comprises inputting the at least one of the representation of the second device or the representation of the user of the second device into the decoder.

9. The method of claim 1, wherein inputting the first acoustic signal into the first machine-learning model comprises inputting a linguistic input representing the first acoustic signal into the first machine-learning model.

10. The method of claim 9, wherein the linguistic input is encoded in a multimodal latent space that includes text and audio.

11. The method of claim 1, wherein the first machine-learning model comprises a neural network.

12. The method of claim 1, wherein the first device comprises a wearable audio device.

13. A system comprising:
a first device comprising one or more processors configured to:
input a first acoustic signal into a first machine-learning model;
generate, with the first machine-learning model, a first bone conduction signal in a time domain or a spectral domain based, at least in part, on the first acoustic signal;
generate, with the first machine-learning model, a transfer function that characterizes a relationship between the first acoustic signal and the first bone conduction signal based, at least in part, on the first acoustic signal; and
train, using at least one of the first bone conduction signal or the transfer function, a second machine-learning model on a second device.

14. The system of claim 13, wherein the one or more processors are further configured to:
input a second acoustic signal captured using a first sensor included in the first device into the second machine-learning model;
input a second bone conduction signal captured using a second sensor included in the first device into the second machine-learning model; and
enhancing or suppressing, on the first device and using the second machine-learning model, speech from a user of the first device present in at least one of the second acoustic signal or the second bone conduction signal.

15. The system of claim 13, wherein the one or more processors are further configured to:
train, using a second acoustic signal and a second bone conduction signal, the first machine-learning model, wherein the second acoustic signal is captured using a first sensor included in a second device and the second bone conduction signal is captured using a second sensor included in the second device and wherein the first device and the second device are the same device model.

16. The system of claim 13, wherein the one or more processors are further configured to:
receive, using a sensor included in a second device, the first acoustic signal, wherein the first device and the second device are the same device model.

17. A non-transitory computer-readable medium comprising computer-executable instructions that, when executed by one or more processors of a first device, cause the first device to perform a method, the method comprising:
inputting a first acoustic signal into a first machine-learning model;
generating, with the first machine-learning model, a first bone conduction signal in a time domain or a spectral domain based, at least in part, on the first acoustic signal;
generating, with the first machine-learning model, a transfer function that characterizes a relationship between the first acoustic signal and the first bone conduction signal based, at least in part, on the first acoustic signal; and
training, using at least one of the first bone conduction signal or the transfer function, a second machine-learning model on a second device.

18. The non-transitory computer-readable medium of claim 17, wherein the method further comprises:
inputting a second acoustic signal captured using a first sensor included in the first device into the second machine-learning model;
inputting a second bone conduction signal captured using a second sensor included in the first device into the second machine-learning model; and
enhancing or suppressing, on the first device and using the second machine-learning model, speech from a user of the first device present in at least one of the second acoustic signal or the second bone conduction signal.

19. The non-transitory computer-readable medium of claim 17, wherein the method further comprises:
training, using a second acoustic signal and a second bone conduction signal, the first machine-learning model, wherein the second acoustic signal is captured using a first sensor included in a second device and the second bone conduction signal is captured using a second sensor included in the second device and wherein the first device and the second device are the same device model.

20. The non-transitory computer-readable medium of claim 17, wherein the method further comprises:
receiving, using a sensor included in a second device, the first acoustic signal, wherein the first device and the second device are the same device model.
